(19) United States
(12) Patent Application Publication
(10) Pub. No.: US 2017/0024328 A1
(43) Pub. Date: Jan. 26, 2017

(54) INFORMATION PROCESSING APPARATUS, INFORMATION PROCESSING METHOD, AND COMPUTER READABLE STORAGE MEDIUM

(71) Applicant: FUJITSU LIMITED, Kawasaki-shi (JP)

(72) Inventor: SATOSHI IMAI, Kawasaki (JP)

(73) Assignee: FUJITSU LIMITED, Kawasaki-shi (JP)

(21) Appl. No.: 15/213,525

(22) Filed: Jul. 19, 2016

(30) Foreign Application Priority Data
Jul. 21, 2015 (JP) 2015-144167

(51) Int. Cl. G06F 12/122

(52) U.S. Cl. CPC G06F 12/122; G06F 2212/69

(57) ABSTRACT

An information processing apparatus including: a memory configured to store size information indicating each size of each data handled in a cache system, access frequency information indicating each access frequency of each data, and a memory space information indicating each size of each of a plurality of memory spaces, the plurality of memory space including one or more specified memory space including a first memory space that stores each data accessed at least twice in a specified period in the cache system, and a processor configured to: calculate one or more specified period in which each data remains in the one or more specified memory spaces respectively based on the size information, the access frequency information, and the memory space information, calculate a cache hit rate of each data in the cache system based on the one or more specified period, and output the cache hit rate.

### CROSS-REFERENCE TO RELATED APPLICATION

This application is based upon and claims the benefit of priority of the prior Japanese Patent Application No. 2015-144167, filed on Jul. 21, 2015, the entire contents of which are incorporated herein by reference.

### FIELD

The embodiments discussed herein are related to performance evaluation techniques for cache systems.

### BACKGROUND

With the spread of in-network caching and information centric networking (ICN), techniques of analyzing the performance of a cache system attract much attention.

A certain literature discloses a technique in which, for memory conditions of a cache system using the least recently used (LRU), the cache hit rates (or cache hit probability) are analytically estimated (hereinafter called the Che approximation). The LRU, which is an algorithm in which data is discarded in order from data having the longest elapsed time period since it was last accessed, is widely used for typical cache systems.

However, among content items of website or Internet video services, there are a large number of content items called “one-times”, which are accessed at very low frequencies. Using the LRU results in “one-timers” being temporarily held in memory, and thus there is a problem in that the cache performance (specifically the cache hit rate) is reduced.

To solve such a problem, the 2Q algorithm and the adaptive replacement caching (ARC) algorithm, in which a memory space is divided into a space for “one-timers” and a space for the other content items, are said to be effective. However, since the 2Q algorithm and the ARC algorithm are complex algorithms that manage a plurality of memory spaces, these algorithms have a difficulty in analytically estimating cache performance compared to the LRU, which is an algorithm that manages a single cache memory.

Japanese Laid-open Patent Publication No. 2005-339198 is an example of related art.

Other examples of related art are disclosed in C. Fricker, P. Robert, J. Roberts, “A Versatile and Accurate Approximation for LRU Cache Performance”, [online], February 2012, the 24th International Teletraffic Congress (ITC), [Jun. 18, 2015], the Internet <URL: http://arxiv.org/pdf/1202.3974.pdf>; T. Johnson, D. Shasha, “2Q: A Low Overhead High Performance Buffer Management Replacement Algorithm”, [online], 1994, Proceedings of the 20th International Conference on Very Large Data Bases, [Jun. 18, 2015], the Internet <URL: http://www.vldb.org/conf/1994/P439.PDF>; and N. Megiddo, D. S. Modha, “ARC: A Self-Tuning, Low OverheadReplacement Cache”, [online], April 2003, The USENIX Association, [Jun. 18, 2015], the Internet <URL: https://www.usenix.org/legacy/event/fast03/tech/full_papers/megiddo/megiddo. pdf>.

### SUMMARY

According to an aspect of the invention, an information processing apparatus includes a memory configured to store size information indicating each size of each data handled in a cache system, access frequency information indicating each access frequency of each data handled in the cache system, and a memory space information indicating each size of each of a plurality of memory spaces used for the cash system, the plurality of memory space including one or more specified memory spaces that stores each data handled in a cache system, the one or more specified memory spaces including a first memory space that stores each data accessed at least twice in a specified period in the cache system, and a processor coupled to the memory and configured to: calculate one or more specified period in which each data remains in the one or more specified memory spaces respectively based on the size information, the access frequency information, and the memory space information, calculate a cache hit rate of each data in the cache system based on the one or more specified period, and output the cache hit rate.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for explaining Simplified 2Q;

FIG. 2 is a diagram illustrating a system outline;

FIG. 3 is a diagram depicting an example of data that is stored in an A1 queue;

FIG. 4 is a diagram depicting an example of data that is stored in an Am queue;

FIG. 5 is a functional block diagram of a performance evaluation device;

FIG. 6 is a diagram depicting an example of data that is stored in a memory condition storage unit in a first embodiment;

FIG. 7 is a diagram depicting an example of data that is stored in a content condition storage unit;

FIG. 8 is a diagram depicting an example of data that is stored in an algorithm selection data storage unit;

FIG. 9 is a diagram depicting an example of data that is stored in a model expression storage unit in the first embodiment;

FIG. 10 is a diagram depicting an example of data that is stored in a result storage unit;

FIG. 11 is a chart illustrating a process flow;

FIG. 12A is a diagram depicting an example of a program in the first embodiment;

FIG. 12B is a diagram depicting the example of the program in the first embodiment;

FIG. 13 includes diagrams depicting measured values and calculated values of cache hit rates;

FIG. 14 is a diagram for explaining Full 2Q;

FIG. 15 is a diagram depicting an example of data that is stored in a memory condition storage unit in a second embodiment;

FIG. 16 is a diagram depicting an example of data that is stored in a result storage unit in the second embodiment;

FIG. 17A is a diagram depicting an example of a program in the second embodiment;

FIG. 17B is a diagram depicting the example of the program in the second embodiment;

FIG. 18 includes diagrams depicting measured values and calculated values of cache hit rates;

FIG. 19 is a diagram for explaining ARC;

FIG. 20 is a diagram for explaining a size of a queue that store pointers;

FIG. 21 is a diagram depicting an example of data that is stored in a memory condition storage unit in a third embodiment;

FIG. 22 is a diagram depicting an example of data that is stored in a result storage unit in the third embodiment;

FIG. 23A is a diagram depicting an example of a program in the third embodiment;

FIG. 23B is a diagram depicting an example of a program in the third embodiment;

FIG. 24 includes diagrams depicting measured values and calculated values of cache hit rates; and

FIG. 25 is a functional block diagram of a computer.

### DESCRIPTION OF EMBODIMENTS

Accordingly, an object of the present disclosure in one aspect is to provide a technique for calculating with high accuracy the performance index of a cache system in which a memory space for caching is divided for use.

### First Embodiment

The 2Q algorithm includes an algorithm called Simplified 2Q and an algorithm called Full 2Q. A first embodiment will be discussed in which performance evaluation for a cache system employing Simplified 2Q is conducted.

First, for reference, the Che approximation will be described. In the Che approximation, the cache hit rate for content (namely, data, handled in the cache system) n having an access frequency of λ(n) and having a size of θ(n) is calculated by the following expression.

H_{LRU}(n)=1−e^{-λ(n)τ}^{_{C}}

In this expression, τ_{C} is a characteristic time parameter representing a time period during which content remains in a queue, and is calculated so as to satisfy the following expression.

$$C = {\sum }_{n = 1}^{N} θ ( n ) ( 1 - {e}^{- λ ( n ) {τ}_{C}} )$$

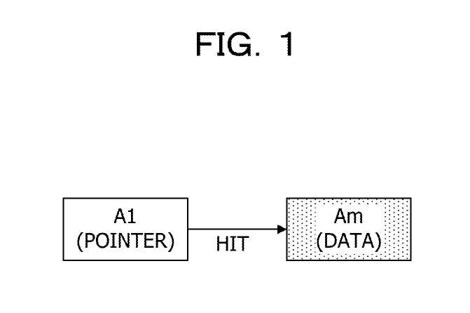

In contrast, in Simplified 2Q, a memory space is divided into two parts. In conjunction with FIG. 1, Simplified 2Q will be described. In FIG. 1, a rectangle represents a memory space. In Simplified 2Q, when access to certain content is first access (namely, the content is accessed once in a specified period), the content is not saved but the history of access (hereinafter called a pointer) is saved in an A1 queue. Further, using the A1 queue, it is determined whether or not access to the certain content is second access (namely, the content is accessed at least twice in the specified period), and, if the access is second access, the content is saved in an Am queue. Content in the Am queue is arranged according to the LRU.

Here, the size of the A1 queue is assumed to be C_{A1}. The size of the A1 queue is expressed by the number of pointers and thus is specified in units of pieces. The size of the Am queue is assumed to be C_{Am}. The size is specified in units of bytes. A cache hit rate H_{S2Q}(n) for content n having an access frequency of λ(n) (the number of times/second) and having a size of θ(n) (byte) is calculated by the following expression.

H_{S2Q}(n)=H_{Am}(n) (1)

In this expression, H_{Am}(n) is the cache hit rate for the content n in the Am queue.

The probability equation of the A1 queue is expressed using the characteristic time parameter τ_{A1} of the A1 queue, as follows.

$${H}_{A 1} ( n ) = \frac{1 - {( 1 - {λ}_{A 1} ( n ) )}^{{τ}_{A 1}}}{2} \\ {λ}_{A 1} ( n ) = λ ( n ) ( 1 - {H}_{Am} ( n ) ) \qquad ( 2 )$$

In the above, H_{A1}(n) is the hit rate for a pointer of the content n in the A1 queue. Further, λ_{A1}(n) represents the probability that the pointer of the content n will be accessed in the A1 queue, and hereinafter is called an access distribution probability of the A1 queue.

The probability equation of the Am queue is expressed using a characteristic time parameter τ_{Am} of the Am queue, as follows.

H_{Am}(n)=1−e^{-λ}^{_{Am}}^{(n)τ}^{_{Am}}

λ_{Am}(n)=λ(n)H_{Am}(n)+λ_{A1}(n)H_{A1}(n) (3)

In the above, λ_{Am}(n) represents the probability that, in the Am queue, the content n will be accessed, and hereinafter is called an access distribution probability of the Am queue.

The characteristic time parameter τ_{A1} satisfies the following queue length condition.

$${C}_{A 1} = {\sum }_{n = 1} {H}_{A 1} ( n ) \qquad ( 4 )$$

The characteristic time parameter τ_{Am} satisfies the following queue length condition.

$${C}_{Am} = {\sum }_{n} θ ( n ) {H}_{Am} ( n ) \qquad ( 5 )$$

Since the model expression given above contains terms expressing mutual influences of a plurality of queues, an appropriate value may be calculated. A method of performing performance evaluation for a cache system using the model expression given above will be described in detail.

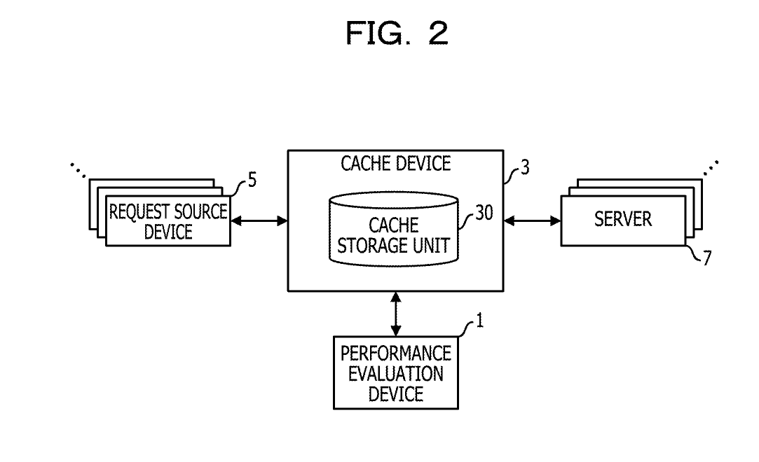

FIG. 2 illustrates an outline of a system in the present embodiment. A performance evaluation device 1, which performs main processing in the present embodiment, is coupled via a network to a cache device 3. The cache device 3 includes a cache storage unit 30. The cache device 3 is coupled via the network to one or a plurality of servers 7 and one or a plurality of request source devices 5. In the present embodiment, data that is stored as a copy of content in the cache device 3 is called a cache.

The request source device 5 transmits a content request for making a request for content managed by the server 7, to the server 7; however, when a cache of the content is stored in the cache storage unit 30, the cache device 3 transmits the cache to the request source device 5. This enables the time taken until completion of a response to the request source device 5 to be reduced. The content is, for example, but not limited to, video data.

The cache storage unit 30 is provided on memory of the cache device 3. In the first embodiment, the cache storage unit 30 is divided into a memory space for the A1 queue and a memory space for the Am queue.

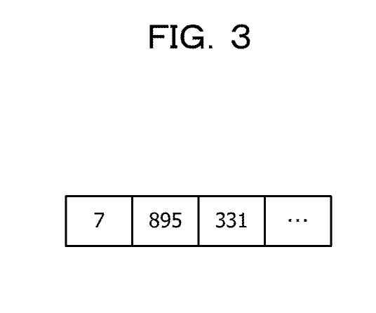

FIG. 3 depicts an example of data that is stored in the A1 queue. In the example of FIG. 3, identifiers (IDs), which are pointers of content, are stored.

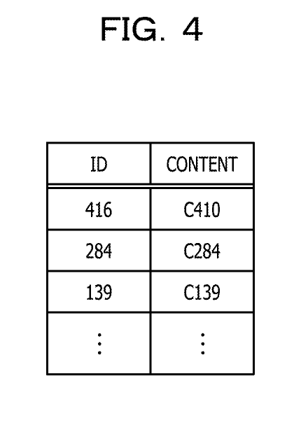

FIG. 4 depicts an example of data that is stored in the Am queue. In the example of FIG. 4, IDs, which are pointers of content, and caches of the content are stored.

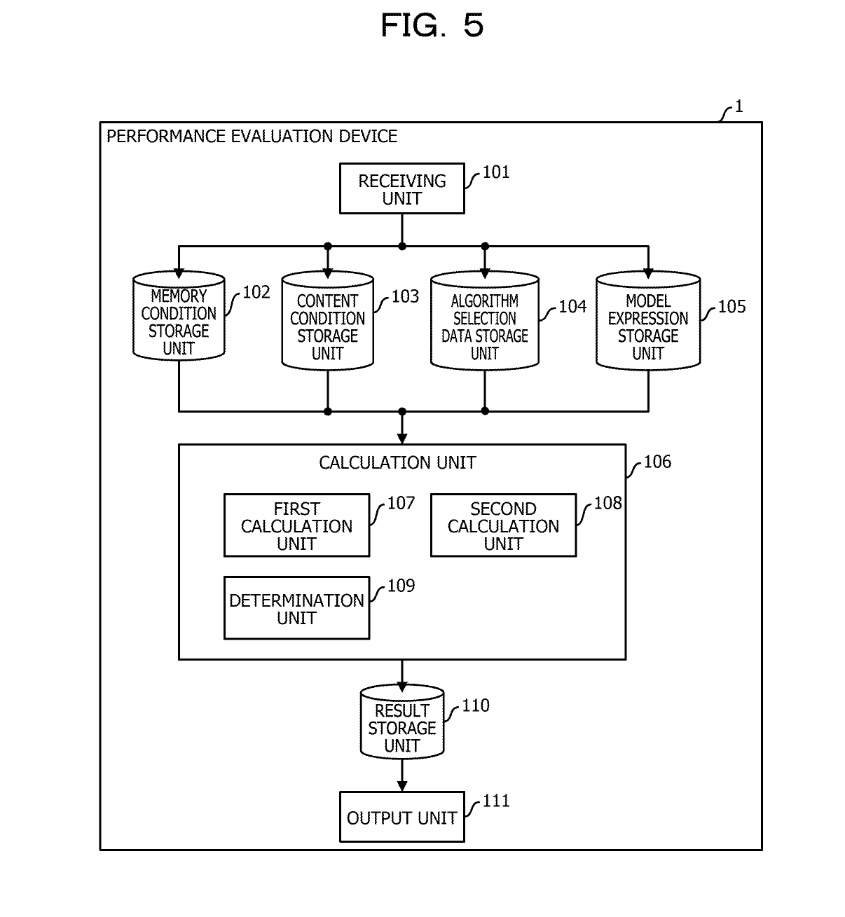

FIG. 5 illustrates a functional block diagram of the performance evaluation device 1. The performance evaluation device 1 includes a receiving unit 101, a memory condition storage unit 102, a content condition storage unit 103, an algorithm selection data storage unit 104, a model expression storage unit 105, a calculation unit 106, a result storage unit 110, and an output unit 111. The calculation unit 106 includes a first calculation unit 107, a second calculation unit 108, and a determination unit 109.

The receiving unit 101 receives input of data from the operator of the performance evaluation device 1 and stores the data in the memory condition storage unit 102, the content condition storage unit 103, the algorithm selection data storage unit 104, and the model expression storage unit 105. The calculation unit 106 performs processing based on data stored in the memory condition storage unit 102, data stored in the content condition storage unit 103, data stored in the algorithm selection data storage unit 104, and data stored in the model expression storage unit 105, and writes processing results to the result storage unit 110. The output unit 111 outputs data stored in the result storage unit 110 (for example, outputting data to a display device, such as a display, or a printer).

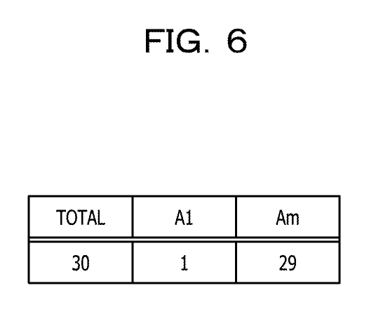

FIG. 6 depicts an example of data that is stored in the memory condition storage unit 102. In the example of FIG. 6, the total size, the size of the A1 queue, and the size of the Am queue are stored.

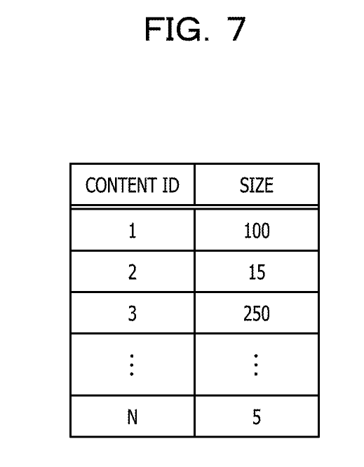

FIG. 7 depicts an example of data that is stored in the content condition storage unit 103. In the example of FIG. 7, content IDs and the sizes of content having the content IDs are stored.

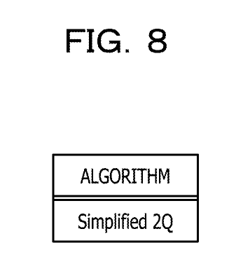

FIG. 8 depicts an example of data that is stored in the algorithm selection data storage unit 104. In the example of FIG. 8, data representing an algorithm that the cache device 3 employs is stored.

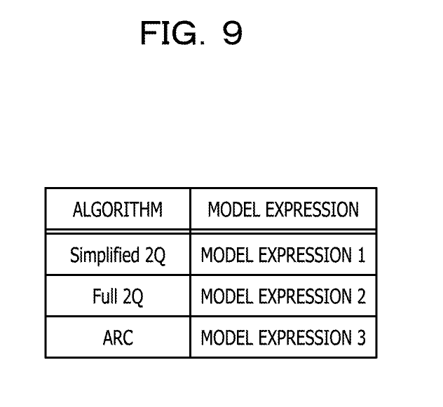

FIG. 9 depicts an example of data that is stored in the model expression storage unit 105. In the example of FIG. 9, algorithm names and model expressions are stored. In the first embodiment, since the cache device 3 employs Simplified 2Q, a model expression 1 is used; however, when other algorithms are employed, other model expressions are used.

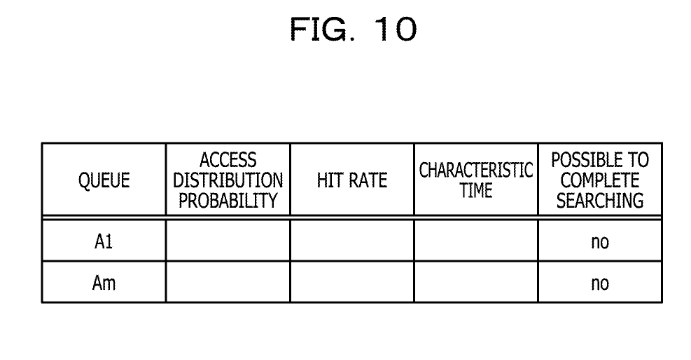

FIG. 10 depicts an example of a data structure of the result storage unit 110. For the A1 queue and the Am queue, the result storage unit 110 includes a field for storing a queue name, a field for storing an access distribution probability, a field for storing a cache hit rate, a field for storing a characteristic time parameter, and a field for storing information indicating whether or not it is possible to complete searching.

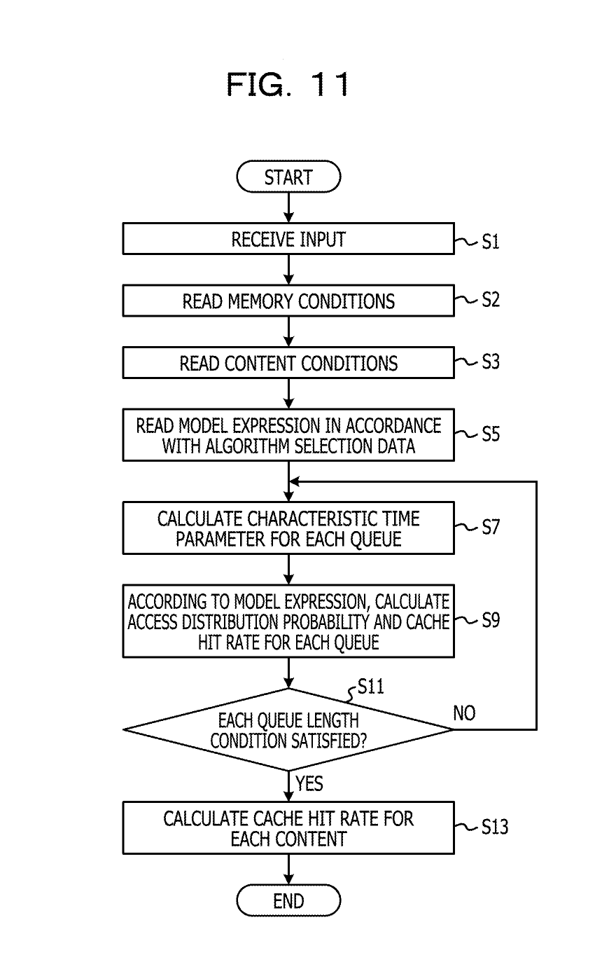

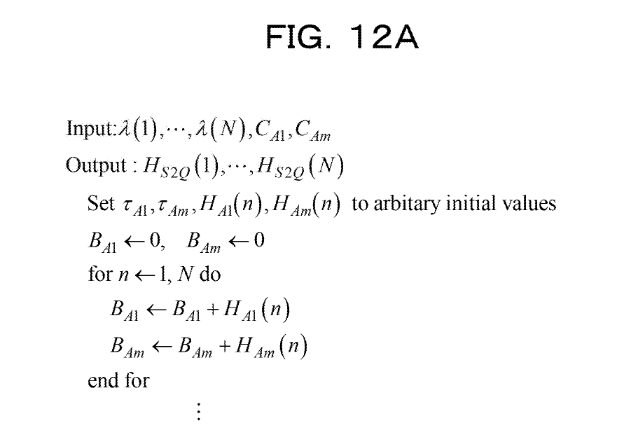

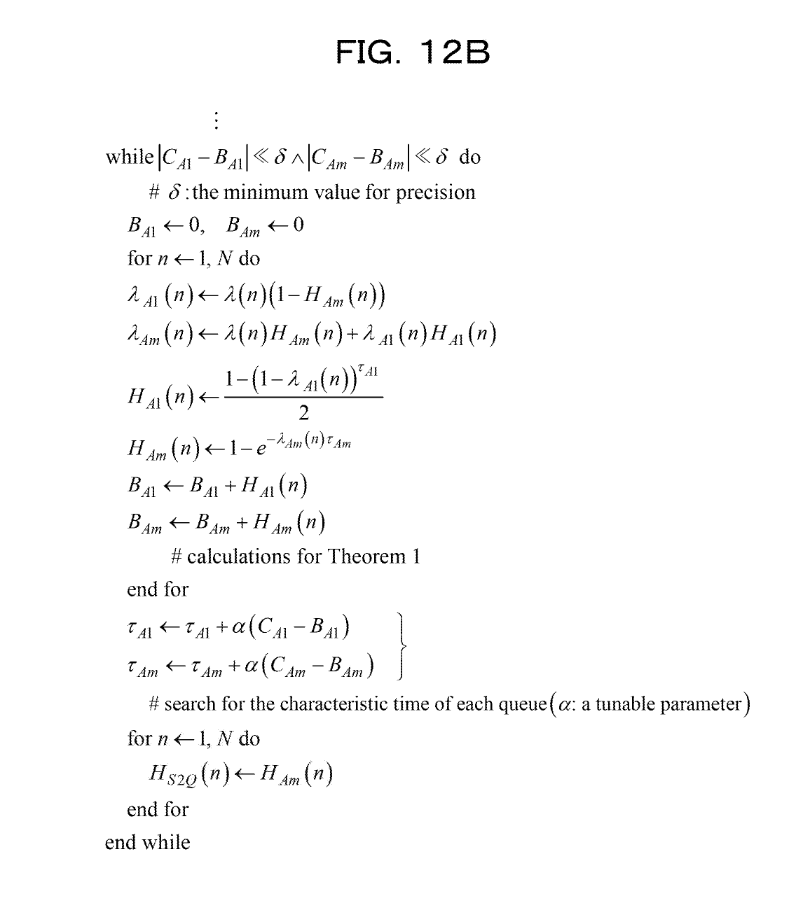

Next, in conjunction with FIG. 11 to FIG. 12B, a process performed by the performance evaluation device 1 will be described in detail.

First, the receiving unit 101 of the performance evaluation device 1 receives input of memory conditions, content conditions, algorithm selection data, and model expressions (step S1 in FIG. 11). The receiving unit 101 stores the memory conditions in the memory condition storage unit 102, stores the content conditions in the content condition storage unit 103, stores the algorithm selection data in the algorithm selection data storage unit 104, and stores the model expressions in the model expression storage unit 105. Although, for the sake of simplicity, description has been given here assuming that input is received simultaneously, the present disclosure is not limited to such an example. For example, in some cases, input of model expressions 1 to 3 is received in advance and the model expressions 1 to 3 are stored in the model expression storage unit 105, and, when performance evaluation is actually performed, input of memory conditions, content conditions, and algorithm selection data is received.

The calculation unit 106 reads the memory conditions from the memory condition storage unit 102 (step S2) and reads the content conditions from the content condition storage unit 103 (step S3). The calculation unit 106 also reads a model expression from the model expression storage unit 105 in accordance with the algorithm selection data stored in the algorithm selection data storage unit 104 (step S5). Since the cache device 3 employing Simplified 2Q is a subject of interest in the first embodiment, a model expression suitable for Simplified 2Q is read.

The first calculation unit 107 calculates a characteristic time parameter for each queue (step S7) and writes the characteristic time parameter calculated to the result storage unit 110. Note that when the process in step S7 is performed for the first time, the initial value of the characteristic time parameter is written to the result storage unit 110. If the process in step S7 is not performed for the first time, a value is added to the previous characteristic time parameter, so that a characteristic time parameter is newly calculated. The way to calculate the parameter is arbitrary but an example of the way is mentioned below.

The second calculation unit 108 calculates an access distribution probability and a cache hit rate for each queue according to the model expression read in step S5 (specifically, expressions (2) and (3)) (step S9), and writes the calculated access distribution probability and cache hit rate to the result storage unit 110.

The determination unit 109 determines, based on data written to the result storage unit 110, whether or not each queue length condition (specifically expressions (4) and (5)) included in the model expression read in step S5 is satisfied (step S11). Note that, for a queue length condition determined as being satisfied, information representing whether or not it is possible to complete searching is set to “yes”.

If each queue length condition is not satisfied (No in step S11), the process returns to step S7. On the other hand, if each queue length condition is satisfied (Yes in step S11), the determination unit 109 calculates the cache hit rate for each content (H_{S2Q}(n) in the first embodiment) based on the data stored in the result storage unit 110 and expression (1) (step S13). Further, the determination unit 109 stores the calculated cache hit rate in the result storage unit 110. Further, the output unit 111 outputs the cache hit rate for each content stored in the result storage unit 110. Thereafter, the process ends.

FIG. 12A and FIG. 12B depict an example of a program for performing the process in steps S5 to S13. FIG. 12A represents the former half of the program and FIG. 12B represents the latter half of the program. In step S7, as depicted in FIG. 12B, the characteristic time parameter is calculated by τ_{A1}→τ_{A1}+α(C_{A1}−B_{A1}) and τ_{Am}→τ_{Am}+α(C_{Am}−B_{Am}). However, the present disclosure is not limited to such a calculation way.

Next, the validity of the method in the first embodiment is demonstrated by comparison between the cache hit rate measured when access to content is simulated and the cache hit rate calculated by the method in the first embodiment. Here, it is assumed that the size of the A1 queue in Simplified 2Q is 50 pieces and the size of the Am queue is 1000 bytes. It is also assumed that the size of each content is 1 byte and the total number of contents is 10000 pieces. The distribution of frequencies (the number of times per second) at which content is accessed is defined by the following Zipfs law.

$$λ ( n ) = \frac{{n}^{- α}}{c}$$

$$c = {\sum }_{k = 1}^{N} {k}^{- α}$$

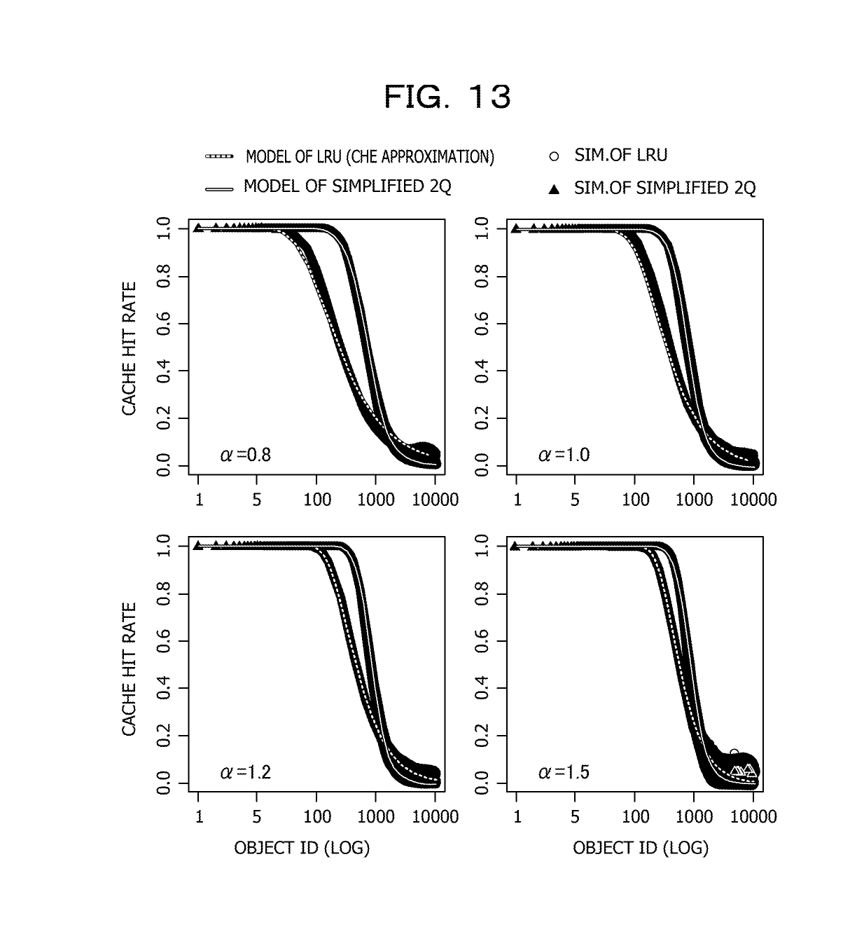

FIG. 13 depict results of simulations and calculation results obtained by the method in the first embodiment. In FIG. 13, for each of the cases where a parameter α of the Zipfs law has values of 0.8, 1.0, 1.2, and 1.5, the results are depicted. The vertical axis represents the cache hit rate of an object (that is, content) and the horizontal axis represents the ID of the object. The value of the ID represents a rank in terms of the level of the access frequency, and the smaller the value, the more frequently the object is accessed.

The open solid line represents cache hit rates according to the model expression in the first embodiment. Triangles represent the cache hit rates obtained when access to content of a system employing Simplified 2Q is simulated. Compared to the LRU, Simplified 2Q has a feature that the cache hit rate of a warm object having a moderate access frequency is high. According to the first embodiment, the cache hit rates obtained when access to content of a system employing Simplified 2Q is simulated are able to be predicted with high accuracy. Note that, for the sake of reference, in FIG. 13, the cache hit rate obtained when access to content of a system employing the LRU is simulated is indicated by a circle, and an open broken line indicates cache hit rates according to the Che approximation. According to the Che approximation, for cache hit rates in a system employing the LRU, it is possible to predict the cache hit rates with high accuracy.

Therefore, according to the present embodiment, verification using a simulation or an actual device does not have to be performed in advance. This enables highly accurate performance evaluation to be achieved in a short time.

### Second Embodiment

A second embodiment will be discussed in which performance evaluation for a cache system employing Full 2Q is conducted.

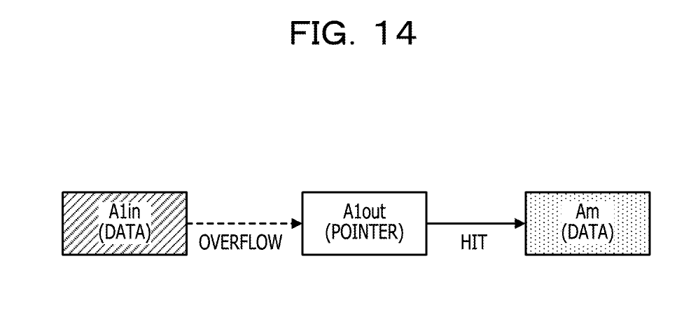

In conjunction with FIG. 14, Full 2Q will be described. In Full 2Q, a memory space is divided into three parts. Regarding first access, an A1in queue, in which content is saved, an A1out queue, in which only pointers are saved, are used. When access to certain content is the first access, the content is saved at the tail end of the A1in queue. If the amount of content in the A1in queue exceeds a threshold, the oldest content (that is, content at the head of the A1in queue) is deleted, and the pointer is saved in the A1out queue. If it is determined by the A1out queue that access is the second access, the content is saved in the Am queue. Content in the Am queue is arranged according to the LRU

Here, it is assumed that the size of the A1in queue is C_{A1in}. The size is specified in units of bytes. It is assumed that the size of the A1out queue is C_{A1out}. The size of the A1out queue is expressed by the number of pointers and thus is specified in units of pieces. It is assumed that the size of the Am queue is C_{Am}. The size is specified in units of bytes. A cache hit rate H_{F2Q}(n) for the content n having the access frequency of λ(n) (the number of requests/second) and having the size of θ(n) (byte) is calculated by the following expression.

H_{F2Q}(n)=H_{A1in}(n)+H_{Am}(n)

In this expression, H_{A1in}(n) is the cache hit rate of the content n in the A1in queue, and H_{Am}(n) is the cache hit rate of the content n in the Am queue.

The probability equation of the A1in queue is expressed using a characteristic time parameter T_{A1in} of the A1in queue, as follows.

H_{A1in}(n)=1−(1−λ_{A1in}(n))^{τ}^{_{A1in}}

λ_{A1in}(n)=λ(n)(1−H_{A1out}(n))(1−H_{Am}(n))

In the above, λ_{A1in}(n) represents the probability that, in the A1in queue, the content n will be accessed, and hereinafter is called an access distribution probability of the A1in queue. Additionally, H_{A1out}(n) is a hit rate for the pointer of the content n in the A1out queue.

The probability equation of the A1out queue is expressed using a characteristic time parameter T_{A1out} of the A1out queue, as follows.

$${H}_{A 1 out} ( n ) = \frac{1 - {( 1 - {λ}_{A 1 out} ( n ) )}^{{τ}_{A 1 out}}}{2}$$

$${λ}_{A 1 out} ( n ) = λ ( n ) ( 1 - {H}_{A 1 in} ( n ) ) ( 1 - {H}_{Am} ( n ) )$$

In the above, λ_{A1out}(n) represents the probability that the pointer of the content n will be accessed in the A1out queue, and hereinafter is called an access distribution probability of the A1out queue.

The probability equation of the Am queue is expressed using the characteristic time parameter τ_{Am} of the Am queue, as follows.

H_{Am}(n)=1−e^{-λ}^{_{Am}}^{(n)τ}^{_{Am}}

λ_{Am}(n)=λ(n)H_{Am}(n)+λ_{A1out}(n)H_{A1out}(n)

In the above, λ_{Am}(n) represents the probability that the content n will be accessed in the Am queue, and hereinafter is called an access distribution probability of the Am queue.

The characteristic time parameter τ_{A1in} satisfies the following queue length condition.

$${C}_{A 1 in} = {\sum }_{n} θ ( n ) {H}_{A 1 in} ( n )$$

The characteristic time parameter τ_{A1out} satisfies the following queue length condition.

$${C}_{A 1 out} = {\sum }_{n} {H}_{A 1 out} ( n )$$

The characteristic time parameter τ_{Am} satisfies the following queue length condition.

$${C}_{Am} = {\sum }_{n} θ ( n ) {H}_{Am} ( n )$$

Consequently, the cache storage unit 30 in the second embodiment is divided into a memory space for the A1in queue, a memory space for the A1out queue, and a memory space for the Am queue. Data that is stored in the A1out queue is similar to the data depicted in FIG. 3, and data that is stored in the A1in queue and data that is stored in the Am queue are similar to the data depicted in FIG. 4.

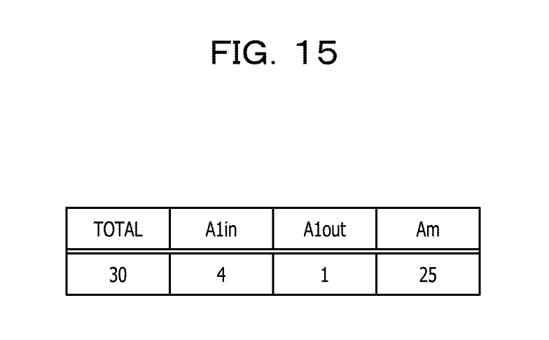

FIG. 15 depicts an example of data that is stored in the memory condition storage unit 102 in the second embodiment. In the example of FIG. 15, the total size, the size of the A1in queue, the size of the A1out queue, and the size of the Am queue are stored.

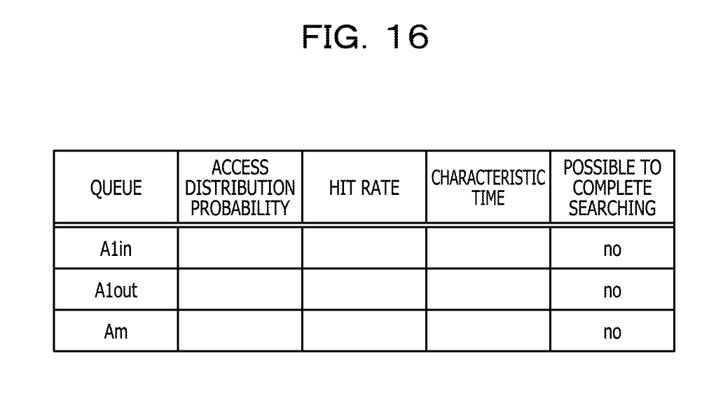

FIG. 16 depicts an example of a data structure of the result storage unit 110 in the second embodiment. For the A1in queue, the A1out queue, and the Am queue, the result storage unit 110 has a field for storing a queue name, a field for storing an access distribution probability, a field for storing a cache hit rate, a field for storing a characteristic time parameter, and a field for storing information indicating whether or not it is possible to complete searching.

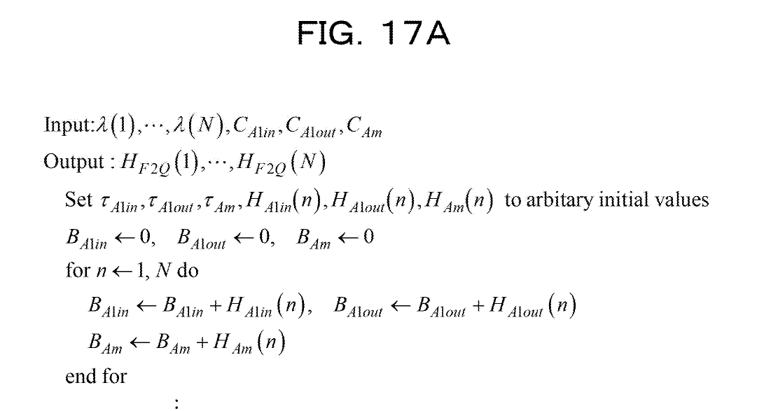

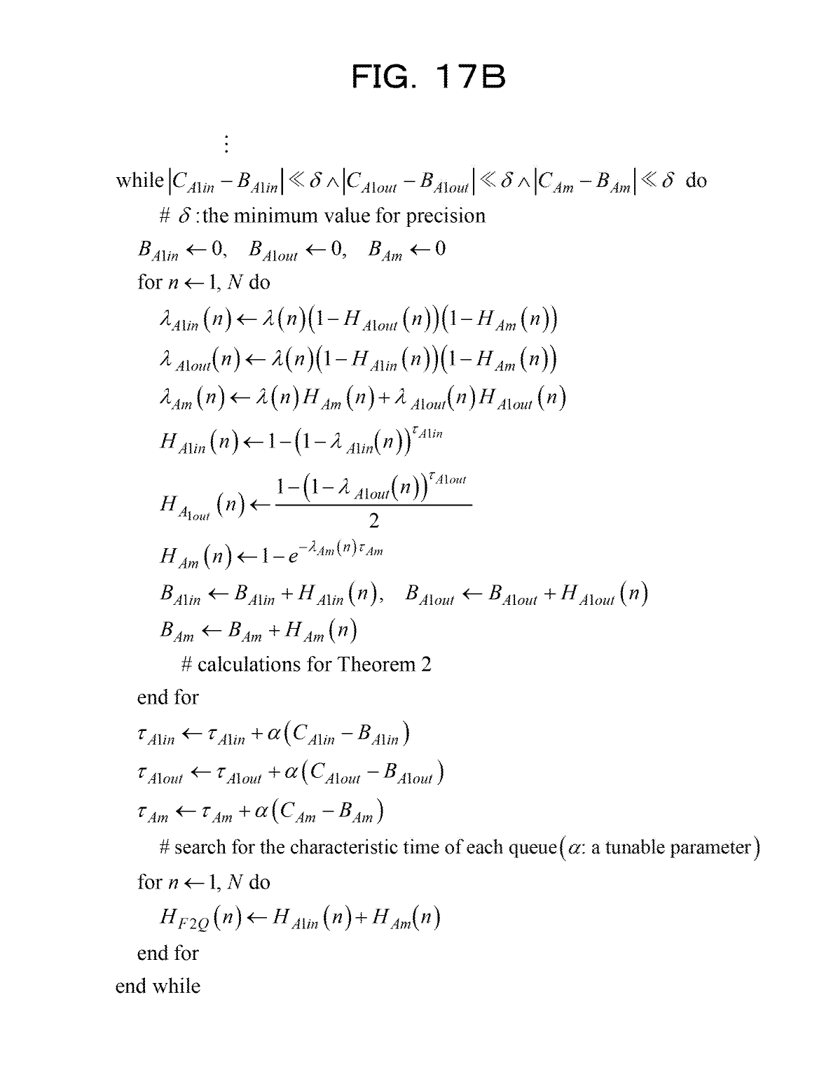

The performance evaluation device 1 in the second embodiment basically performs processing similar to that performed by the performance evaluation device 1 in the first embodiment. However, in the second embodiment, since the algorithm selection data indicates “Full 2Q”, a program for performing the process in steps S5 to S13 is as depicted in FIG. 17A and FIG. 17B. FIG. 17A depicts the former half of the program, and FIG. 17B depicts the latter half of the program.

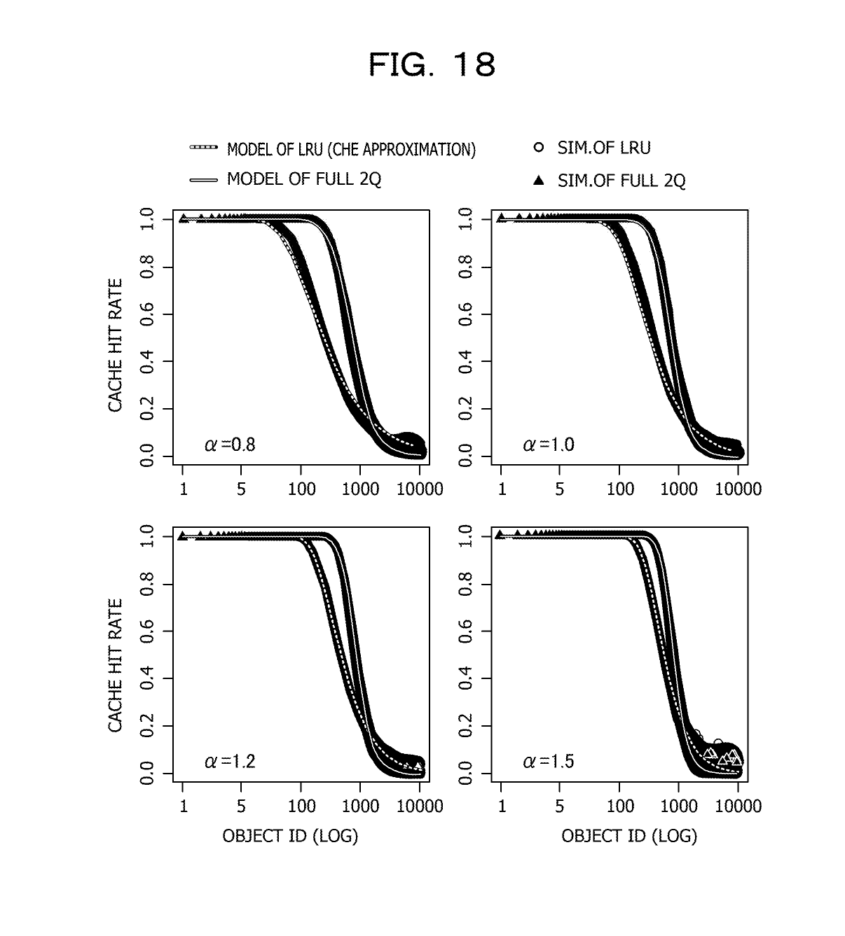

FIG. 18 depicts results of simulations and calculation results obtained by the method in the second embodiment. In the simulations, it is assumed that the size of the A1in queue in Full 2Q is 10 bytes, the size of the A1out queue is 500 pieces, and the size of the Am queue is 1000 bytes. It is also assumed that the size of each content is 1 byte and the total number of pieces of content is 10000 pieces. In FIG. 18, for each of the cases where the parameter α of the Zipf's law has values of 0.8, 1.0, 1.2, and 1.5, results are depicted. The vertical axis represents the cache hit rate (probability) of an object (that is, content) and the horizontal axis represents the ID of the object. The value of the ID represents the rank in terms of the level of the access frequency, and the smaller the value, the more frequently the object is accessed.

The open solid line represents cache hit rates according to the model expression in the second embodiment. Triangles represent cache hit rates obtained when access to content of a system employing Full 2Q is simulated. Compared to the LRU, Full 2Q has a feature that the cache hit rate of a warm object having a moderate access frequency is high. According to the method of the second embodiment, the cache hit rates obtained when access to content in a system employing Full 2Q is simulated are able to be predicted with high accuracy. Note that, for the sake of reference, in FIG. 18, the cache hit rate obtained when access to content in a system employing the LRU is simulated is indicated by a circle, and an open broken line indicates cache hit rates according to the Che approximation. According to the Che approximation, it is possible to predict cache hit rates with high accuracy if they are cache hit rates in a system employing the LRU.

### Third Embodiment

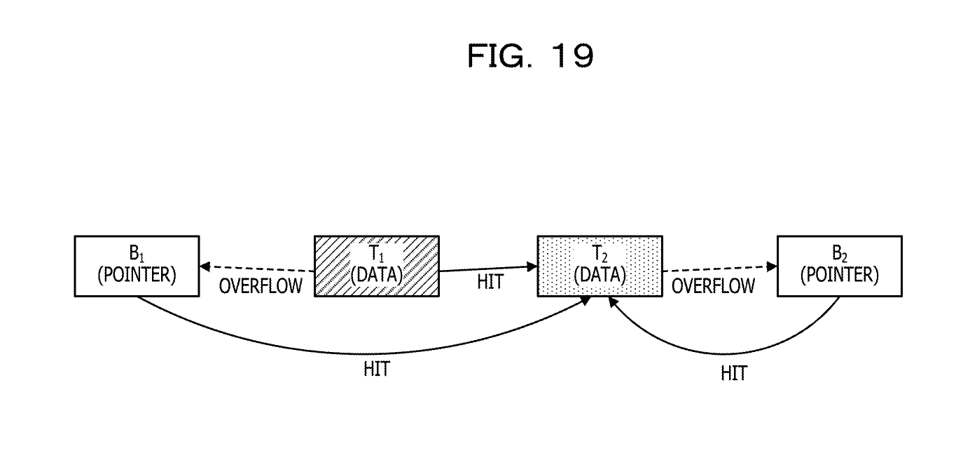

In conjunction with FIG. 19, ARC will be described. In ARC, a memory space is divided into four parts. Regarding first access, a T₁ queue, in which content is saved, and a B₁ queue, in which only pointers are saved, are used. Regarding second access, a B₂ queue, in which only pointers are saved, and a T₂ queue, in which content is saved, are used. Regarding the first access, content is saved at the tail end of the T₁ queue. If the amount of content in the T₁ queue exceeds a threshold, the oldest content (that is, content at the head of the T₁ queue) is deleted, and the pointer is saved in the B₁ queue. Regarding the second access, content is saved at the tail end of the T₂ queue. If the amount of content in the T₂ queue exceeds a threshold, the oldest content (that is, content at the head of the T₂ queue) is deleted, and the pointer is saved in the B₂ queue. Content in the T₂ queue is arranged according to the LRU. Note that, unlike in 2Q, in ARC, the size of each queue is dynamically changed in accordance with an access pattern.

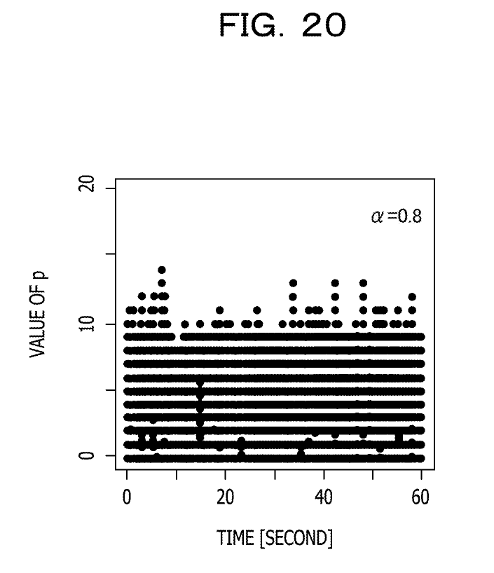

However, as depicted in FIG. 20, in a cache system that actually employs ARC, it is verified that the size of the T₁ queue and the size of the B₂ queue account for about 1 percentage of the entire queue size (assumed here to be 1000) and are so small that their ranges of variations are negligible. In FIG. 20, the horizontal axis represents time (second) and the vertical axis represents the size of the T₁ queue and the size of the B₂ queue, p.

In a third embodiment, fixed replacement caching (FRC) (p=1) is employed in which the size of the T₁ queue and the size of the B₂ queue are handled as each having a fixed value. For the sake of simplification of the calculation, it is assumed that the number of pieces of content as is represents the amount of data. In this case, assuming that the size of the T₁ queue is p (byte), the size of the B₁ queue is C-p (piece), the size of the T₂ queue is C-p (byte), and the size of the B₂ queue is p (piece).

Accordingly, a cache hit rate H_{FRC}(n) for the content n having an access frequency of λ(n) (the number of times/second) is calculated by the following expression.

H_{FRC}(n)=H_{T}_{₁}(n)+H_{T}_{₂}(n)

In this expression, H_{T1}(n) is a cache hit rate of the content n in the T₁ queue, and H_{T2}(n) is a cache hit rate of the content n in the T₂ queue. Herein, for formatting convenience, T₁ and T₂, which use numerical subscripts, are denoted as T1 and T2. The same applies to B₁ and B₂.

The probability equation of the B₁ queue is expressed using a characteristic time parameter τ_{B1} of the B₁ queue, as follows.

$${H}_{{B}_{1}} ( n ) = \frac{1 - {( 1 - {λ}_{{B}_{1}} ( n ) )}^{{τ}_{{B}_{1}}}}{2}$$

$${λ}_{{B}_{1}} ( n ) = λ ( n ) ( 1 - {H}_{{T}_{1}} ( n ) ) ( 1 - {H}_{{T}_{2}} ( n ) ) ( 1 - {H}_{{B}_{2}} ( n ) )$$

In the above, λ_{B1}(n) represents the probability that the pointer of the content n will be accessed in the B₁ queue, and hereinafter is called an access distribution probability of the B₁ queue. Additionally, H_{B2}(n) is a hit rate for the pointer of the content n in the B₂ queue.

The probability equation of the T₁ queue is expressed using a characteristic time parameter τ_{T1} of the T₁ queue, as follows.

$${H}_{{T}_{1}} ( n ) = \frac{1 - {( 1 - {λ}_{{T}_{1}} ( n ) )}^{{τ}_{{T}_{1}}}}{2}$$

$${λ}_{{T}_{1}} ( n ) = λ ( n ) ( 1 - {H}_{{T}_{2}} ( n ) ) ( 1 - {H}_{{B}_{2}} ( n ) ) ( 1 - {H}_{{B}_{1}} ( n ) )$$

In the above, λ_{T1}(n) represents the probability that the content n will be accessed in the T₁ queue, and hereinafter is called an access distribution probability of the T₁ queue. Additionally, H_{B1}(n) is a hit rate for the pointer of the content n in the B₁ queue.

The probability equation of the T₂ queue is expressed using a characteristic time parameter τ_{T2} of the T₂ queue, as follows.

$${H}_{{T}_{2}} ( n ) = 1 - {e}^{- {λ}_{{T}_{2}} ( n ) {τ}_{{T}_{2}}}$$

$${λ}_{{T}_{2}} ( n ) = λ ( n ) {H}_{{T}_{2}} ( n ) + {λ}_{{T}_{1}} ( n ) {H}_{{T}_{1}} ( n ) + {λ}_{{B}_{1}} ( n ) {H}_{{B}_{1}} ( n ) + {λ}_{{B}_{2}} ( n ) {H}_{{B}_{2}} ( n )$$

In the above, λ_{T2}(n) represents the probability that the content n will be accessed in the T₂ queue, and hereinafter is called an access distribution probability of the T₂ queue.

The probability equation of the B₂ queue is expressed using a characteristic time parameter τ_{B1} of the B₂ queue, as follows.

$${H}_{{B}_{2}} ( n ) = \frac{1 - {( 1 - {λ}_{{B}_{2}} ( n ) )}^{{τ}_{{B}_{1}}}}{2}$$

$${λ}_{{B}_{2}} ( n ) = λ ( n ) ( 1 - {H}_{{T}_{1}} ( n ) ) ( 1 - {H}_{{T}_{2}} ( n ) ) ( 1 - {H}_{{B}_{1}} ( n ) )$$

In the above, λ_{B2}(n) represents the probability that the pointer of the content n will be accessed in the B₂ queue, and hereinafter is called an access distribution probability of the B₂ queue.

The characteristic time parameter τ_{B1} satisfies the following queue length condition.

$$C - p = {\sum }_{n} {H}_{{B}_{1}} ( n )$$

The characteristic time parameter τ_{T1} satisfies the following queue length condition.

$$p = {\sum }_{n} {H}_{{T}_{1}} ( n )$$

The characteristic time parameter τ_{T2} satisfies the following queue length condition.

$$C - p = {\sum }_{n} {H}_{{T}_{2}} ( n )$$

The characteristic time parameter τ_{B2} satisfies the following queue length condition.

$$p = {\sum }_{n} {H}_{{B}_{2}} ( n )$$

Consequently, the cache storage unit 30 in the third embodiment is divided into a memory space for the B₁ queue, a memory space for the T₁ queue, a memory space for the T₂ queue, and a memory space for the B₂ queue. Data that is stored in the B₁ queue and data that is stored in the B₂ queue are similar to the data depicted in FIG. 3, and data that is stored in the T₁ queue and data that is stored in the T₂ queue are similar to the data depicted in FIG. 4.

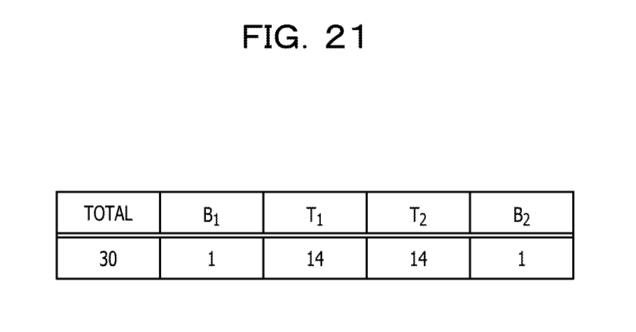

FIG. 21 depicts an example of data that is stored in the memory condition storage unit 102 in the third embodiment. In the example of FIG. 21, the total size, the size of the B₁ queue, the size of the T₁ queue, the size of the T₂ queue, and the size of the B₂ queue are stored.

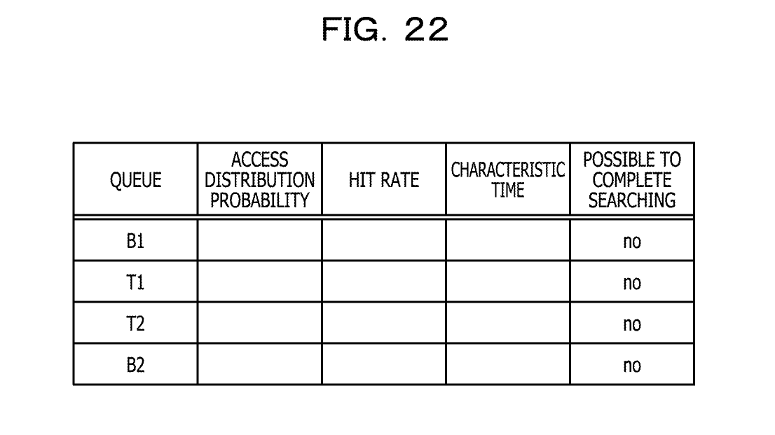

FIG. 22 depicts an example of a data structure of the result storage unit 110 in the third embodiment. For the B₁ queue, the T₁ queue, the T₂ queue, and the B₂ queue, the result storage unit 110 has a field for storing a queue name, a field for storing an access distribution probability, and a field for storing a cache hit rate, a field for storing a characteristic time parameter, and a field for storing information indicating whether or not it is possible to complete searching.

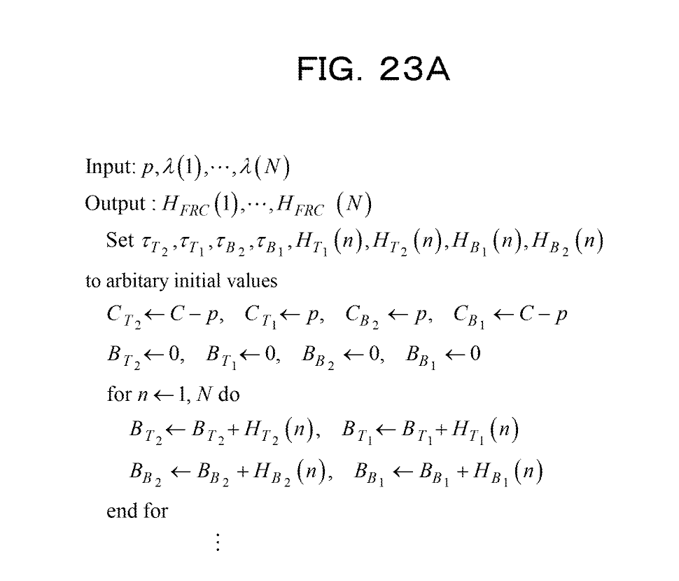

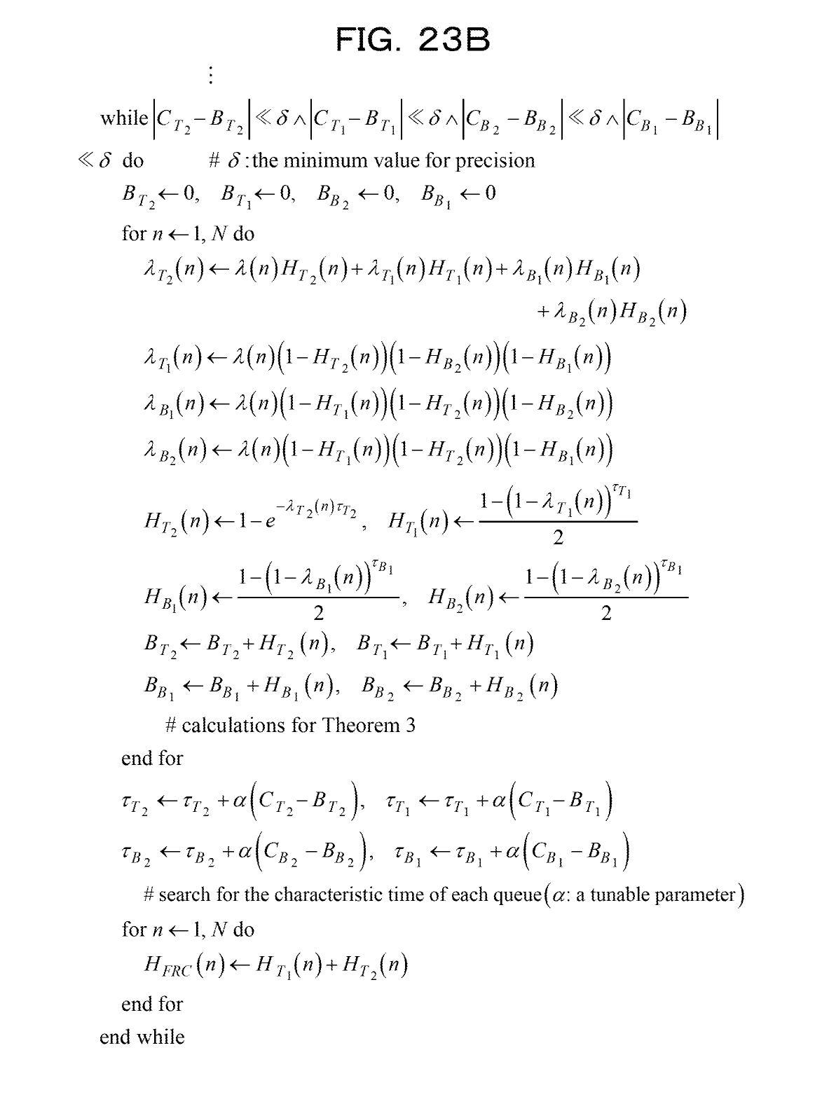

The performance evaluation device 1 in the third embodiment basically performs processing similar to that performed by the performance evaluation device 1 in the first embodiment. However, in the third embodiment, since the algorithm selection data indicates “ARC”, a program for performing the process in steps S5 and S13 is as depicted in FIG. 23A and FIG. 23B. FIG. 23A depicts the former half of the program, and FIG. 23B depicts the latter half of the program.

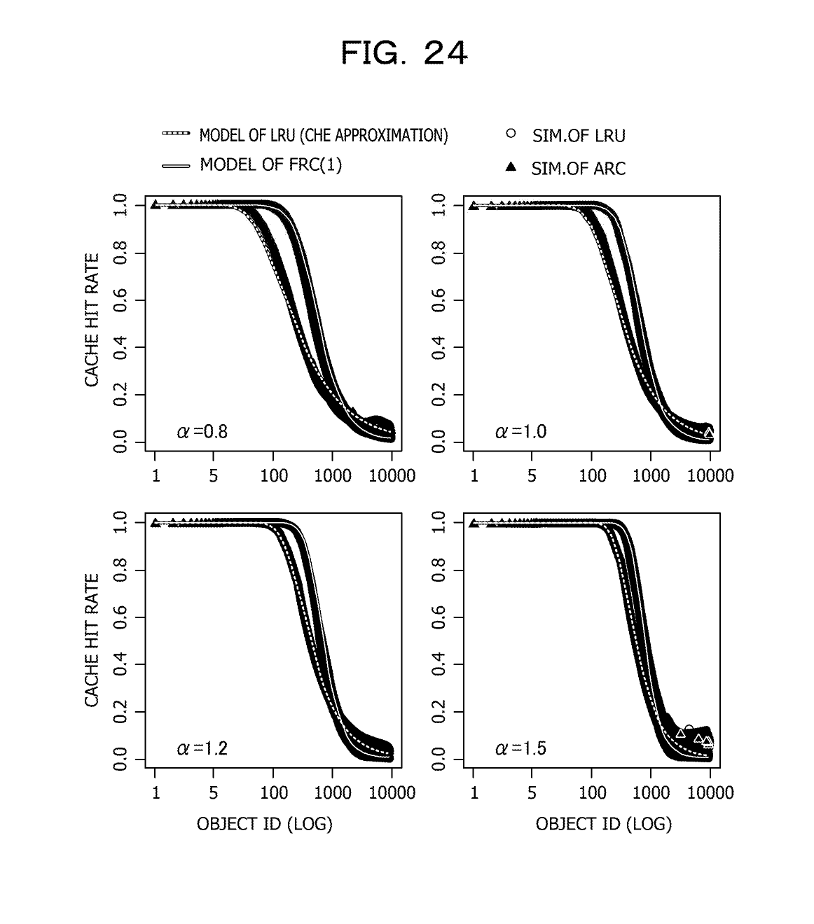

FIG. 24 depicts results of simulations and calculation results obtained by the method of the third embodiment. In the simulations, it is assumed that p=1 and C=1000. It is also assumed that the size of each piece of content is 1 byte and the total number of pieces of content is 10000 pieces. In FIG. 24, for each of the cases where the parameter α of the Gipfs law is 0.8, 1.0, 1.2, and 1.5, the results are depicted. The vertical axis represents the cache hit rate of an object (that is, content), and the horizontal axis represents the ID of the object. The value of the ID represents a rank in terms of the level of the access frequency, and the smaller the value, the more frequently the object is accessed.

The open solid line represents the cache hit rate according to a model expression in the third embodiment. Triangles represent cache hit rates obtained when access to content of a system employing ARC is simulated. Compared to the LRU, ARC has a feature that the cache hit rate of a warm object having a moderate access frequency is high. According to the third embodiment, the cache hit rates obtained when access to content in a system employing ARC is simulated are able to be predicted with high accuracy. Note that, for the sake of reference, in FIG. 24, the cache hit rate obtained when access to content in a system employing the LRU is simulated is indicated by a circle, and an open broken line represents cache hit rates according to the Che Approximation. According to the Che Approximation, it is possible to predict cache hit rates with high accuracy if they are cache hit rates in a system employing the LRU.

Although one embodiment of the present disclosure has been described, the present disclosure is not limited to this. For example, in some cases, the functional block configuration of the performance evaluation device 1 and the cache device 3 described above is not the same as the actual program module configuration.

The configurations of the tables described above are examples and have not to have configurations as described above. Further, in the processing flow, it is possible to replace the order in which processing is performed, unless the replacement results in a change in the processing result. Further, processing may be performed in parallel.

Although, in step S1, input of data is received from the user, data may be acquired from another device coupled via a network.

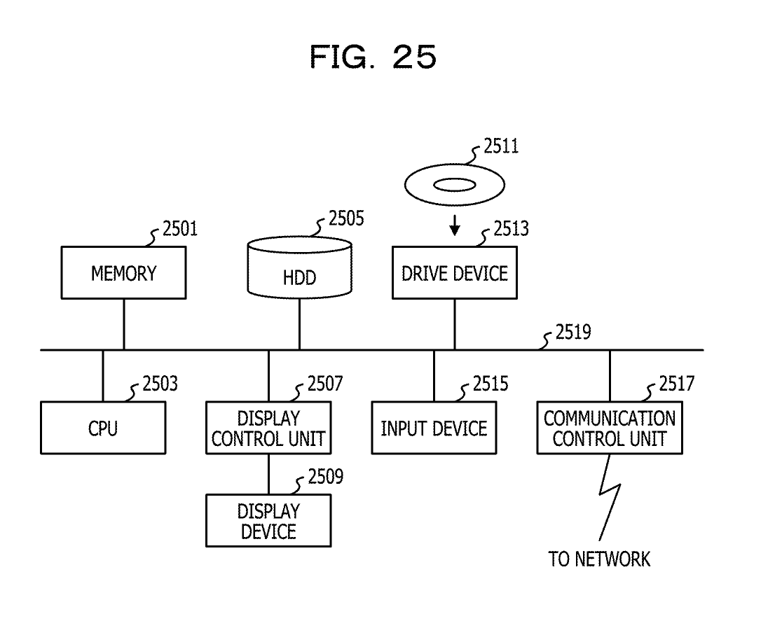

Note that the performance evaluation device 1, the cache device 3, the request source device 5, and the server 7 are computer devices, and, as illustrated in FIG. 25, memory 2501, a central processing unit (CPU) 2503, a hard disk drive (HDD) 2505, a display control unit 2507 coupled to a display device 2509, a drive device 2513 for a removable disk 2511, an input device 2515, and a communication control unit 2517 for coupling to a network are coupled by a bus 2519. An operating system (OS) and application programs for performing processing in the present embodiment are stored in the HDD 2505 and are read from the HDD 2505 to the memory 2501 at the time of being executed by the CPU 2503. The CPU 2503 controls the display control unit 2507, the communication control unit 2517, the drive device 2513 in accordance with the processing details of the application programs, so that they perform given operations. Data being processed is primarily stored in the memory 2501 but may be stored in the HDD 2505. In the embodiments of the present disclosure, application programs for carrying out the processing described above are stored and distributed on the computer-readable removal disk 2511 for carrying out the processing described above, and are installed from the drive device 2513 to the HDD 2505. There are some cases where the application programs are installed to the HDD 2505 via a network such as the Internet and the communication control unit 2517. Such a computer device implements various types of functions as described above through organic cooperation of hardware, such as the CPU 2503 and the memory 2501, and programs, such as the OS and the application programs, mentioned above.

Summarizing the embodiments of the present disclosure described above gives the following.

An information processing apparatus according to a first aspect of the present embodiments includes (A) a first calculation unit that, based on sizes of a plurality of data blocks, sizes of a plurality of memory spaces each storing a cache of a data block or identification information of a data block, and frequencies of access to the plurality of data blocks, calculates, for each of the plurality of memory spaces, a parameter representing a time period for remaining in the memory space, the parameter satisfying a given condition; and (B) a second calculation unit that calculates, from the parameter calculated for a first memory space storing a cache of a data block among the plurality of memory spaces, a cache hit rate for the first memory space and calculates a total sum of the cache hit rate calculated.

In such a way, even with a cache system employing an algorithm using a plurality of memory spaces, it is enabled to calculate cache hit rates with high accuracy. Note that the number of first memory spaces may be more than one.

Additionally, the given condition described above may include a first condition for the size of the memory space, a second condition for a cache hit rate of a data block in the memory space, and a third condition for a frequency of access to the data block in the memory space. This enables the parameter to have a suitable value.

Additionally, the second calculation unit described above may (b1) calculate a cache hit rate for the first memory space from the parameter calculated for the first memory space, a frequency of access to the data block in the first memory space, and the second condition. This enables the cache hit rate for the first memory space to have a suitable value.

Additionally, the first condition described above may include a first condition expression for calculating the size of the memory space, from the frequency of access to the data block in the memory space or the frequency of access to the data block in the memory space and the size of the data block, the second condition may include a second condition expression for calculating the cache hit rate of the data block in the memory space from the frequency of access to the data block in the memory space and the parameter, and the third condition may include a third condition expression for calculating the frequency of access to the data block in the memory space from a frequency of access to a data block and a cache hit rate of the data block in a memory space different from the memory space. It is possible to take account the mutual effects of a plurality of memory spaces, thus enabling an appropriate parameter to be calculated.

Additionally, the number of memory spaces storing caches of data blocks, among the plurality of memory spaces, and the number of memory spaces storing identifiers of data blocks, among the plurality of memory spaces, may be one. This enables the cache hit rates of a cache system employing Simplified 2Q to be calculated with high accuracy.

Additionally, the number of memory spaces storing caches of data blocks, among the plurality of memory spaces, may be two, and the number of memory spaces storing identifiers of data blocks, among the plurality of memory spaces, may be one. This enables the cache hit rates of a cache system employing Full 2Q to be calculated with high accuracy.

Additionally, the number of memory spaces storing caches of data blocks, among the plurality of memory spaces, may be two, and the number of memory spaces storing identifiers of data blocks, among the plurality of memory spaces, may be two. This enables the cache hit rates of a cache system employing ARC to be calculated with high accuracy.

A performance evaluation method according to a second aspect of the present embodiments includes (C) based on sizes of a plurality of data blocks, sizes of a plurality of memory spaces each storing a cache of a data block or identification information of a data block, and the number of the plurality of data blocks, calculating, for each of the plurality of memory spaces, a parameter representing a time period for remaining in the memory space; and (D) calculating, from the parameter calculated for a first memory space storing a cache of a data block among the plurality of memory spaces, a cache hit rate for the first memory space and calculating a total sum of the cache hit rate calculated.

In the above embodiments, the cache hit rate is estimated based on specified sizes of memory spaces and so on. In that case, sizes of memory spaces and so on are inputted and the estimated cache hit rate is outputted. On the contrary, required sizes of memory spaces may be estimated based on a desired cache hit rate and so on. In that case, the desired cache hit rate and so on are inputted and the estimated required sizes of memory spaces are outputted. The estimated required sizes of memory spaces may be fed back. In the other words, new sizes of memory spaces may be autonomously reset or reconfigured based on the estimated required sizes of memory spaces.

Note that it is possible to create a program for causing a computer to execute a process using the above method, and the program is stored, for example, on a computer-readable storage medium, such as a flexible disk, a CD-ROM, a magneto-optical disk, semiconductor memory, or a hard disk, or a storage device. Note that intermediate processing results are temporarily kept in a storage device, such as main memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a memory configured to store size information indicating each size of each data handled in a cache system, access frequency information indicating each access frequency of each data handled in the cache system, and a memory space information indicating each size of each of a plurality of memory spaces used for the cash system, the plurality of memory space including one or more specified memory spaces that stores each data handled in a cache system, the one or more specified memory spaces including a first memory space that stores each data accessed at least twice in a specified period in the cache system; and
a processor coupled to the memory and configured to:
calculate one or more specified period in which each data remains in the one or more specified memory spaces respectively based on the size information, the access frequency information, and the memory space information,
calculate a cache hit rate of each data in the cache system based on the one or more specified period, and
output the cache hit rate.

2. The information processing apparatus according to claim 1, wherein
the cache hit rate of each data in the cache system is a sum of one or more specified cache hit rates of each data in the one or more specified memory spaces.

3. The information processing apparatus according to claim 2, wherein
each size of each of the one or more specified memory spaces is determined based on a product of each size of each data handled in a cache system and each of the one or more specified cache hit rates of each data in the one or more specified memory spaces.

4. The information processing apparatus according to claim 1, wherein
the plurality of memory spaces include a second memory space that stores each pointer of each data accessed once in the specified period in the cache system.

5. The information processing apparatus according to claim 4, wherein
the one or more specified memory spaces include a third memory space that stores each data accessed once in the specified period in the cache system.

6. The information processing apparatus according to claim 5, wherein
the plurality of memory spaces include a fourth memory space that stores each pointer of each data accessed at least twice in the specified period in the cache system.

7. An information processing method comprising:
storing size information indicating each size of each data handled in a cache system, access frequency information indicating each access frequency of each data handled in the cache system, and a memory space information indicating each size of each of a plurality of memory spaces used for the cash system, the plurality of memory space including one or more specified memory spaces that stores each data handled in a cache system, the one or more specified memory spaces including a first memory space that stores each data accessed at least twice in a specified period in the cache system;
calculating one or more specified period in which each data remains in the one or more specified memory spaces respectively based on the size information, the access frequency information, and the memory space information;
calculating a cache hit rate of each data in the cache system based on the one or more specified period; and
outputting the cache hit rate.

8. A non-transitory computer readable storage medium that stores a program for image processing that causes a computer to execute a process comprising:
storing size information indicating each size of each data handled in a cache system, access frequency information indicating each access frequency of each data handled in the cache system, and a memory space information indicating each size of each of a plurality of memory spaces used for the cash system, the plurality of memory space including one or more specified memory spaces that stores each data handled in a cache system, the one or more specified memory spaces including a first memory space that stores each data accessed at least twice in a specified period in the cache system;
calculating one or more specified period in which each data remains in the one or more specified memory spaces respectively based on the size information, the access frequency information, and the memory space information;
calculating a cache hit rate of each data in the cache system based on the one or more specified period; and
outputting the cache hit rate.
